(19) United States
(12) Patent Application Publication
(10) Pub. No.: US 2021/0291970 A1
(43) Pub. Date: Sep. 23, 2021

(54) METHOD OF CONTROLLING AT LEAST ONE PROPELLER OF A HYBRID HELICOPTER, AND A HYBRID HELICOPTER

(71) Applicant: AIRBUS HELICOPTERS, Marignane (FR)

(72) Inventor: Paul EGLIN, Roquefort La Bedoule (FR)

(73) Assignee: AIRBUS HELICOPTERS, Marignane (FR)

(21) Appl. No.: 17/176,439

(22) Filed: Feb. 16, 2021

(30) Foreign Application Priority Data
Mar. 17, 2020 (FR) 2002608

(51) Int. Cl. B64C 27/06; B64C 11/44

(52) U.S. Cl. CPC B64C 27/06; B64C 11/44

(57) ABSTRACT

A method of controlling at least one first propeller of a hybrid helicopter, the hybrid helicopter having a thrust control for controlling a first pitch of the first blades of the first propeller. The thrust control includes a movable control member. The method includes the following steps: the thrust control continuously transmitting a control signal carrying a control setpoint to the control system; the control system transforming the control setpoint into a pitch setpoint; and the control system controlling the first pitch by applying the pitch setpoint.

### CROSS-REFERENCE TO RELATED APPLICATIONS

This application claims priority to French patent application No. FR 2002608 filed on Mar. 17, 2020, the disclosure of which is incorporated in its entirety by reference herein.

### BACKGROUND OF THE INVENTION

### (1) Field of the Invention

The present invention relates to a method of controlling at least one propeller of a hybrid helicopter, and also to a hybrid helicopter applying this method. The invention lies in the technical field of control systems for a hybrid helicopter.

The project leading to this invention received funding from the European Union Framework Programme for Research and Innovation Horizon 2020, through the grant agreement CleanSky 2 No. “GAM-FRC-2014-001 Issue E”.

### (2) Description of Related Art

Due to its specificity and for convenience, one type of rotorcraft may be referred to as a “hybrid helicopter”. A hybrid helicopter has an airframe carrying at least one rotary wing provided with a rotor, that rotor being referred to, for convenience, as a “lift rotor” due to a function it performs. The lift rotor participates at least in providing lift for the aircraft, and indeed can also participate in providing forward propulsion for it.

A hybrid helicopter further includes at least one propeller, possibly of the puller propeller type or of the pusher propeller type. For example, the hybrid helicopter may be provided with at least two propellers arranged transversely on either side of an airframe and of its anteroposterior plane of symmetry.

Examples of hybrid helicopters are disclosed, for example, in Documents U.S. Pat. Nos. 8,181,901, 8,170,728, 8,052,094, and 8,113,460.

Furthermore, a hybrid helicopter includes a power plant for setting in motion each propeller and the lift rotor, optionally continuously except during failure or during testing.

To pilot a hybrid helicopter, a pilot of the hybrid helicopter can operate a first control and a second control for respectively collectively and cyclically controlling the pitch of the blades of the lift rotor, e.g. via a mechanical and/or electrical architecture. The first control is referred to, for convenience, as the “collective pitch control” and often takes the form of a lever referred to as the “collective pitch lever”. The second control is referred to, for convenience, as the “cyclic pitch control” and often takes the form of a stick referred to as the “cyclic stick”.

In particular on a hybrid helicopter having at least two propellers situated on either side of an airframe, the pitch of the blades of each propeller is a function of a mean pitch component and of a differential pitch component. Thus, the first pitch of the first blades of a first propeller may be equal to the sum of the mean pitch component plus the differential pitch component, while the second pitch of the second blades of a second propeller may be equal to the mean pitch component minus the differential pitch component. Furthermore, the mean pitch component may be equal to the half-sum of the first and second pitches of the two propellers, while the differential pitch component may be equal to the half-difference of the first and second pitches of the two propellers.

In this situation, steering or “directional” control functions, in particular for yaw control, can be performed by using a yaw control suitable for modifying the value of the differential pitch component. For example, such a yaw control may comprise pedals connected via a control system having mechanical and/or electrical architecture to the propellers. The pedals enable the value of the differential pitch component to be modified.

Furthermore, the hybrid helicopter includes at least one thrust control that is suitable for modifying the value of the mean pitch component, via the control system.

The thrust control may take the form of a button that has three discrete states.

Document FR 2 946 316 describes such a pulse control that generates pulses that can take the states −1, 0, or +1 and that are transmitted to an integrator. That document describes various modes of operation, including a direct mode, in which the value of the mean pitch component results directly from operating the pulse control. In a regulated mode, the power consumed by the propeller(s) is regulated as a function of a power setpoint coming directly from operating the thrust variation pulse control. During a forced mode, in the event of autorotating, the mean pitch component is forced automatically under control of the pilot, to a computed pitch value. Finally, a protected mode is also described.

Document WO 2016/043943 discloses a control method and a control mechanism provided with a toggle or rocker switch that is movable between a neutral position and a plurality of non-neutral positions. In that control method, that plurality of positions of the toggle switch includes a first non-neutral position serving to generate movement of the blades of a propeller in a first direction, a second non-neutral position serving to generate movement of the blades of a propeller in a second direction, and a third non-neutral position serving to cause the blades of a propeller to be moved into positions inducing zero thrust generated by the propeller.

Furthermore, WO 2016/043943 also discloses that that control method generates a pitch setpoint as from the non-neutral position in which the toggle switch is positioned and for a duration for which the toggle switch is maintained in said non-neutral position.

Document EP 3 503 149 relates to an electrical control mechanism (1) provided with a support (5). A central body (10) that is movable in rotation about a central axis of rotation carries a button (3) that is movable in rotation relative to the central body (10) about an offset axis of rotation parallel to the central axis of rotation. Two primary electric switches (31, 34) are interposed between the button (3) and the central body (10) on either side of a plane (100) containing said central axis of rotation and the offset axis of rotation. Two secondary electric switches (41, 44) are interposed between the support (5) and the central body (10) on either side of said plane.

Document EP 3 309 061 discloses an electric control device provided with operating or “manipulation” means and with a support, the manipulation means being movable relative to said support, the manipulation means being designed to be moved relative to the support by a person, the electric control device including a first measurement system that takes a first measurement of a current position of the manipulation means relative to a neutral position.

Such an electric control device also includes a second measurement system that takes a second measurement of the current position, the first measurement system and the second measurement system being independent and dissimilar, the control device including a processor unit comparing the first measurement and the second measurement in order to generate a control signal as a function of said current position, the processor unit considering the manipulation means to be in the neutral position when the first measurement and the second measurement do not correspond to the same position for the manipulation means.

That Document EP 3 309 061 also discloses a method comprising the following steps:

generating the first measurement and the second measurement;

comparing the first measurement and the second measurement; and

generating a variation rate, for the additional thrust or for the pitch of the blades of the propulsion system, in order to control the additional thrust as a function of the position of said manipulation means relative to a reference, said variation rate being generated as a function of a “measured position” of the manipulation means when the first measurement and the second measurement correspond simultaneously to the measured position of the manipulation means, said variation rate being set at zero when the first measurement and the second measurement do not correspond to the same position of the manipulation means.

Document WO 2011/048399 discloses a helicopter electric control that includes force feedback means suitable for generating forces on a stick using a non-linear force relationship.

Document US 2004/093130 discloses a method of controlling an aircraft by means of a control setpoint or command consisting, for example, of a longitudinal acceleration setpoint or command.

Document WO 2016/054147 discloses a method of controlling an aircraft by means of a control setpoint or command consisting, for example, of a power setpoint or command.

### BRIEF SUMMARY OF THE INVENTION

An object of the present invention is thus to propose an alternative method for controlling the propellers of a hybrid helicopter. More precisely, an object of the present invention may be to improve the reactivity of a method of controlling the pitch of the blades of a propeller equipping a hybrid helicopter.

The invention thus provides a method of controlling at least one first propeller or indeed also at least one second propeller of a hybrid helicopter, said hybrid helicopter including a lift rotor, said hybrid helicopter including a control system connected to first blades of the first propeller, and, where applicable, to second blades of the second propeller, said hybrid helicopter having a thrust control for controlling a first pitch of the first blades, and, where applicable, for controlling a second pitch of the second blades, the thrust control being in communication with the control system. Optionally, the thrust control may control a mean pitch component when the pitch of the propeller(s) is broken down into a mean pitch component and a differential pitch component.

The thrust control includes a control member that is movable with at least one degree of freedom relative to a carrier member. For example, the control member is movable by a pilot along a movement path at least between two end positions and may be positioned in any position along said movement path between said two end positions, and including said two end positions. The method includes the following steps:

continuously transmitting with the thrust control a control signal that carries a control setpoint to the control system, said control signal being an analog electrical signal and at each instant being a function of a current position of the control member relative to the carrier member, at least outside failure situations;

transforming with the control system the control setpoint into a pitch setpoint; and

controlling with the control system the first pitch and the second pitch by applying said pitch setpoint.

The expression “at least outside failure situations” means that the control signal is a function of the current position of the control member along its movement path so long as the thrust control is operating properly. In the event of a failure of the thrust control, the control signal is a function of the current position of the control member in a first alternative, and is not a function of the current position of the control member in a second alternative. For example, in the second alternative, if the thrust control encounters a failure, the control signal may take a predetermined refuge form.

Thus, the control system may include a mechanical architecture provided with actuators, e.g. hydraulic or pneumatic actuators, and/or a mechanical architecture provided with electric actuators. In addition, the control system may include at least one control computer or the like in communication with at least one actuator and the thrust control.

Unlike a pulse-type control, the thrust control continuously issues a control signal that varies as a function of the position of the control member relative to the carrier member. This position may be referred to as the “current position” for convenience.

For example, this control signal may be an analog electrical signal. For example, said analog electrical signal has a DC voltage that varies as a function of the current position. In another example, said analog electrical signal has an AC voltage that has an amplitude that varies as a function of the current position.

In another example, the thrust control includes an encoder wheel that is movable jointly with the control member, a reader continuously issuing a digital signal as a function of the current position of the encoder wheel.

In this situation, the thrust control continuously transmits a control signal to the control system. The control system receives said control signal. The control signal varies as a function of the position of the control member, relative to the carrier member.

Furthermore, the term “carrying” or “carries” means that the control signal is the image of the value of a control setpoint for a physical parameter, the form of the control signal reflecting the value of the control setpoint controlled by a pilot.

The control system interprets the control signal as having a form that is a function of a control setpoint. Optionally, during this step, an analog-to-digital converter enables a control signal of the analog type to be converted into a digital value of the control setpoint. In the presence of a control signal of the digital type, the control signal may provide the value of the control setpoint directly. In this situation, and on the basis of the control signal, the control system determines a pitch setpoint, and, for example, and where applicable, a mean pitch setpoint for the pitch of the blades of the propeller(s). The control system controls at least one actuator for complying with the control setpoint.

This method may enable a pilot to dose the control precisely by controlling the value of a desired control setpoint and/or to reach the desired operating point rapidly.

The method may include one or more of the following characteristics.

Thus, the method may include a step of applying a return force to said control member so as to place said control member in a reference position relative to the carrier member in the absence of any force being exerted by a human pilot on the control member.

In this possibility, a return system may urge the control member to be placed in a reference position generating a particular order. When the control member is in the reference position, the control signal carries a setpoint aiming to have a specific action on the hybrid helicopter. For example, the reference position is a position that generates a control setpoint taking a value of zero.

For example, the current position of the control member may be identified by the position of a predetermined point of the control member relative to a position reached by said point in the reference position.

In one aspect, the return force may vary in compliance with a force relationship, said force relationship providing said return force exerted on said control member by the return system as a function of said position of the control member relative to the carrier member.

The force necessary for moving the control member away from its reference position may increase as a pilot moves said control member.

The return force may be proportional to the movement.

Alternatively, the force relationship may be non-linear.

In one aspect, said at least one degree of freedom may include a degree of freedom to move in rotation, or indeed may comprise only one degree of freedom that is a degree of freedom to move in rotation.

For example, the control member may move in rotation relative to the carrier member about an axis of rotation through more or less 45 degrees relative to a reference position. Optionally, the control member may include a knurled wheel that is movable in rotation about an axis of rotation.

In another possibility, said at least one degree of freedom may include a degree of freedom to move in translation, or indeed may comprise only one degree of freedom that is a degree of freedom to move in translation.

In another aspect and in a first implementation, said control setpoint is a longitudinal acceleration setpoint.

The longitudinal acceleration represents the acceleration of the hybrid helicopter along an axis going from the rear of the aircraft to the front of the aircraft, e.g. substantially parallel to the roll axis of the hybrid helicopter.

Thus, when the control member is in a reference position, the control signal carries a longitudinal acceleration setpoint that is zero. The control system controls the propellers to maintain the forward speed of the hybrid helicopter constant.

When the control member is in a position in the range from the reference position to a first end position, the control signal carries a longitudinal acceleration setpoint that is positive. The control system controls the propellers to accelerate the hybrid helicopter in order to increase its forward speed.

When the control member is in a position in range from the reference position to a second end position, the control signal carries a longitudinal acceleration setpoint that is negative. The control system controls the propellers to decelerate the hybrid helicopter.

This first implementation may tend to accelerate or decelerate the hybrid helicopter rapidly and precisely.

In a second implementation, said control setpoint is a setpoint for a rate and a direction of pivoting of the first propeller blades about their pitch axes.

The control signal carries a setpoint for modifying the first pitch of the first blades and, where applicable, the second pitch of the second blades, at a certain rate and in a particular direction.

Thus, when the control member is in a reference position, the control signal carries a setpoint for not modifying the first pitch of the first blades and, where applicable for not modifying the second pitch of the second blades.

When the control member is in a position in the range from the reference position to a first end position, the control signal carries an order to pivot each blade of the propeller(s) about its pitch axis in a first direction at a particular rate, the rate depending on the current position of the control member. The control system controls the propeller(s) accordingly.

When the control member is in a position in the range from the reference position to a second end position, the control signal carries a rate of pivoting of each blade of the propeller(s) about its pitch axis in a second direction opposite from the first direction, the rate depending on the current position of the control member. The control system controls the propeller(s) accordingly. For example, the rate of pivoting setpoint for pivoting each blade of a propeller about its pitch axis takes a positive value when the blade is to pivot in a first direction, and a negative value when the blade is to pivot in the opposite direction.

In a third implementation, said control setpoint is a power setpoint.

The first implementation, the second implementation, and the third implementation are mutually compatible. For example, a pilot may choose the implementation to be applied.

To this end, the method may include a selection step using a human-machine interface to select a physical parameter for the control setpoint, said physical parameter being chosen by a pilot and being a longitudinal acceleration setpoint or a setpoint for a rate and a direction of pivoting of the first blades and, where applicable, of the second blades, or a power setpoint, said human-machine interface transmitting a control signal carrying the chosen parameter to the control system.

In another approach, said method may include a selection step using a human-machine control to select a selected automatic piloting mode, a physical parameter of the control setpoint varying as a function of the selected automatic piloting mode, said human-machine control transmitting a control signal carrying said selected automatic piloting mode to the control system.

Indeed, the hybrid helicopter may have an automatic piloting system suitable for implementing a plurality of piloting modes. Such an automatic piloting system may be of the type known as an “Automatic Flight Control System” (AFCS). The physical parameter that is the subject of the control setpoint may vary as a function of the automatic piloting mode that is engaged. For example, by default and when no automatic piloting mode is engaged, the control setpoint may be a direct setpoint for controlling the pitch of the blades of the propeller(s), e.g. in the above-mentioned third implementation. But if, for example, the pilot uses the AFCS to engage a piloting mode to maintain a speed, such as the speed known as the “Indicated Air Speed” (IAS), then the control setpoint may be an IAS setpoint. As from a certain forward speed or as from a certain power consumption, or in another piloting mode, the control setpoint may, for example, be a power setpoint.

In addition to providing the method, the invention provides a hybrid helicopter provided with at least one first propeller, or indeed also with at least one second propeller, said hybrid helicopter including a lift rotor, said hybrid helicopter including a control system connected to first blades of the first propeller and, where applicable, to second blades of the second propeller, said hybrid helicopter having a thrust control in communication with the control system.

The control system is configured to apply the method of the invention.

In one aspect, said thrust control includes a control member that is movable with at least one degree of freedom relative to a carrier member. Said thrust control may include a return system that exerts a return force on said control member so as to place said control member in said reference position in the absence of any force being exerted by a human pilot on the control member.

For example, the return system may comprise at least one spring or the like.

In one aspect, the return force may vary in compliance with a force relationship, said force relationship providing said return force as a function of the position of the control member.

In another possibility or in addition, the thrust control may include a return system comprising an electric actuator. Said electric actuator exerts a return force on said control member so as to generate, in usual manner, a force on the control member that varies in compliance with a force relationship.

In one aspect, the hybrid helicopter may include a human-machine interface for choosing a physical parameter for the control setpoint, said physical parameter being chosen by a pilot and being a longitudinal acceleration setpoint or a setpoint for a rate and a direction of pivoting of the first blades and, where applicable of the second blades, or a power setpoint, said human-machine interface transmitting a control signal carrying the chosen parameter to the control system.

Alternatively, said hybrid helicopter includes a human-machine control for choosing a selected automatic piloting mode from among a plurality of automatic piloting modes, said human-machine control transmitting a control signal carrying said selected automatic piloting mode to the control system.

The human-machine control enables an automatic piloting mode to be selected, the piloting setpoint varying as a function of the selected automatic piloting mode.

In one aspect, the control member is movable in rotation or in translation relative to a carrier member.

### BRIEF DESCRIPTION OF THE DRAWINGS

The invention and its advantages appear in greater detail from the following description of examples given by way of illustration with reference to the accompanying figures, in which:

FIG. 1 is a diagrammatic view of a hybrid helicopter of the invention;

FIG. 2 is a diagrammatic view of a control system for controlling the propellers of a hybrid helicopter of the invention;

FIG. 3 is a diagrammatic view of a control system for controlling the propellers of a hybrid helicopter of the invention;

FIG. 4 is a view of a control member that is movable in translation;

FIG. 5 is a view of a control member that is movable in rotation;

FIG. 6 is a graph showing examples of force relationships;

FIG. 7 is a view showing the applied method;

FIG. 8 is a view showing a direct operating mode with a control signal carrying a longitudinal acceleration setpoint; and

FIG. 9 is a view showing a direct operating mode with a control signal carrying a rate of movement setpoint or a power setpoint.

### DETAILED DESCRIPTION OF THE INVENTION

Elements present in more than one of the figures are given the same references in each of them.

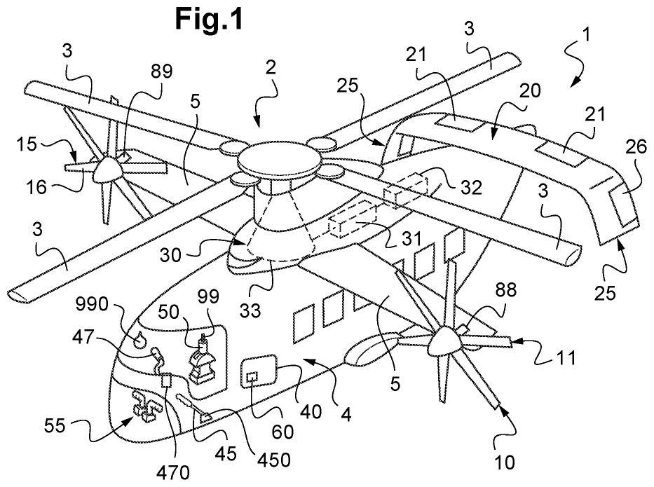

FIG. 1 shows a hybrid helicopter 1 of the invention.

This hybrid helicopter 1 has a fuselage 4 above which at least one lift rotor 2 is arranged. The lift rotor 2 is provided with a plurality of blades referred to for convenience as “main blades 3”.

In addition, the hybrid helicopter 1 is provided with at least one “first propeller” of the puller type or of the pusher type. For example, the hybrid helicopter 1 is provided with at least one first propeller 10 and with at least one second propeller 15. The first and second propellers 10, 15 respectively have a plurality of first blades 11 and a plurality of second blades 16. The first propeller 10 and the second propeller 15 may be disposed laterally relative to the fuselage 4, and in particular on either side of an anteroposterior plane of the hybrid helicopter 1. In FIG. 1, the sides on which the first and second propellers 10, 15 are arranged may be reversed. The first and second propellers 10, are optionally carried by a support 5. Such a support 5 may optionally be aerodynamic. For example, the support 5 comprises a wing as shown in FIG. 1. In FIG. 1, the propellers 10, 15 are placed at the leading edge of a wing. In another example, the propellers 10, 15 may be placed at the trailing edge of the wing.

Furthermore, the hybrid helicopter 1 may include surfaces for stabilizing or indeed maneuvering purposes, i.e. stabilizer surfaces and movable control surfaces. For example, for longitudinal (pitch) stability and control, the hybrid helicopter 1 may include at least one substantially horizontal stabilizer 20, optionally provided with movable pitch control surfaces or “elevators” 21. For example, for directional (yaw) stability and control, the hybrid helicopter 1 may include at least one substantially vertical stabilizer 25, optionally provided with movable fins or “rudders” 26. FIG. 1 thus shows a tail assembly that is in the shape of an upside-down U, but the tail assembly may have various shapes without going beyond the ambit of the invention. In another example, the tail assembly may be H-shaped, U-shaped, etc. For example, the teaching from Patent FR 3 074 142 is also applicable.

Furthermore, the hybrid helicopter 1 includes a power plant 30 for delivering power to the lift rotor 2 and optionally to each propeller 10, 15. For this purpose, the power plant 30 includes at least one engine 31 that is controlled by a usual engine computer 32.

The term “computer” is used below to mean a unit that may, for example, comprise at least one processor and at least one memory, at least one integrated circuit, at least one programmable system, or at least one logic circuit, these examples not limiting the scope given to the expression “computer”. The term “processor” may be used equally well to mean a central processing unit (CPU), a graphics processing unit (GPU), a digital signal processor (DSP), a microcontroller, etc.

In addition, for example inside an interconnection system, the power plant 30 may further include at least one gearbox, at least one shaft, and/or at least one member for interconnecting two members in rotation, etc. For example, one or more engines 31 are connected mechanically via one or more mechanical connection channels to a main gearbox 33 that drives the lift rotor 2 in rotation. Furthermore, the main gearbox 33 may be connected mechanically via respective shafts to side gearboxes, one for each of the propellers 10, 15, which side gearboxes are then in turn connected to the corresponding propellers 10, 15.

The speeds of rotation of the outlets of the engine(s) 31, of the propellers 10, 15, of the lift rotor 2, and of the mechanical interconnection system are optionally mutually proportional, with the proportionality ratio optionally being constant regardless of the flight configuration of the hybrid helicopter 1 under normal operating conditions, i.e. except for failure, testing or training situations.

Furthermore, the hybrid helicopter 1 may include various controls for being piloted.

In particular, the hybrid helicopter 1 may include a control system 40 connected to flight controls for collectively and cyclically controlling the pitch of the main blades 3. Such a control system 40 may, for example, include a set of swashplates. Thus, at each instant, the pitch of the main blades 3 may be equal to the sum of a collective pitch that is identical for all of the main blades 3 and of a cyclic pitch that varies as a function of the azimuth position of each main blade 3. The pitch of the main blades 3 is referred to as the “main pitch” so as to be clearly distinguished from the pitches of the other blades.

The hybrid helicopter 1 may then include a collective pitch control 45 that can be operated by a pilot and that acts on at least one mechanical and/or electrical control channel of the control system 40 to cause the main pitch of the main blades 3 to vary collectively, where applicable via the set of swashplates. For example, the collective pitch control 45 may comprise a lever. In addition, the collective pitch control 45 may be provided with a collective pitch sensor 450 that emits an analog, digital, electrical, or optical signal that varies as a function of the position of a moving member. For example, the collective pitch control 45 comprises a lever and a collective pitch sensor 450 including at least one angular position sensor for assessing a position of the lever, such as, for example, a potentiometer. The collective pitch sensor 450 may also be arranged on a moving member jointly with the collective pitch control, e.g. downstream from series actuators and/or trim actuators, as applicable.

Similarly, the hybrid helicopter 1 may include a cyclic pitch control 47 that can be operated by a pilot and that acts on one or more mechanical and/or electrical control channels of the control system to cause the pitch of the main blades 3 to vary cyclically, where applicable via the set of swashplates. In addition, the cyclic pitch control 47 may be provided with a position sensor 470 that emits an analog, digital, electrical, or optical signal that varies as a function of the position of a moving member. For example, the cyclic pitch control 47 comprises a stick and a position sensor 470 including at least two angular position sensors for assessing a position of the stick, such as, for example, potentiometers.

In usual manner, the hybrid helicopter 1 may include controls connected to the control system 40 for controlling the pitch of the blades of the propeller(s), and, in particular, the pitch of the first blades 11 and the pitch of the second blades 16, as in the example shown. At each instant, and in particular in the presence of two propellers, the first pitch of the first blades 11 of the first propeller 10 may be equal to the sum of a mean pitch component and of a differential pitch component, while the second pitch of the second blades 16 of the second propeller 15 is equal to the difference between the mean pitch component and the differential pitch component.

Optionally, the hybrid helicopter 1 includes a first measurement sensor 88 for measuring the first value of the first pitch and a second measurement sensor 89 for measuring the second value of the second pitch. For example, the first measurement sensor 88 includes a position sensor that emits an analog, digital, electrical, or optical signal that varies as a function of the position of a control shaft for controlling the pitch of the first blades 11. Similarly, the second sensor 89 may include a position sensor that emits an analog, digital, electrical, or optical signal that varies as a function of the position of a control shaft for controlling the pitch of the second blades 16. Each position sensor may be of a usual type and, for example, comprise a speed sensor serving to obtain a position by integration, a potentiometer, etc.

In usual manner, the hybrid helicopter 1 may include a thrust control 50 that can be operated by a pilot and that acts on one or more mechanical and/or electrical control channels of the control system 40 to cause the pitch of the propeller(s) to vary, e.g. so as to control a forward speed of the hybrid helicopter 1. For example, the thrust control 50 may either control the total pitch of the propeller(s) or control the value of a mean pitch component, where applicable.

Similarly, the hybrid helicopter 1 may include a yaw control 55 that can be operated by a pilot and that acts on one or more mechanical and/or electrical control channels of the control system 40 to cause the differential pitch component of the pitch of the first blades 11 and of the pitch of the second blades 16 to vary, as applicable. The yaw control may, for example, take the form of pedals.

Furthermore, the control system 40 may include one or more control computers 60 that are in communication at least with the thrust control 50 so as to apply the method of the invention and optionally also with the first measurement sensor 88, with the second measurement sensor 89 and/or with the collective pitch sensor 450, or indeed with one or more above-mentioned controls.

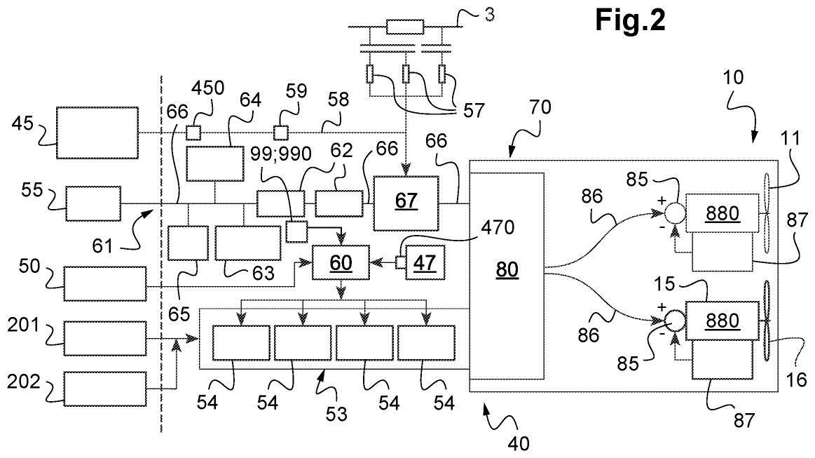

FIG. 2 shows an example of a control system 40 for controlling the propellers 10, 15.

In this control system 40, the collective pitch control is connected to a collective pitch control channel 58 of the control system 40 for controlling the collective pitch component of the main blades 3. For example, the collective pitch control 58 includes at least three servo-controls 57 hinged to a non-rotary swashplate of the set of swashplates, this set of swashplates including a rotary swashplate connected via pitch connecting rods to a pitch lever of each main blade 3. Optionally, the collective pitch control channel 58 includes at least one actuator 59 controlled by the control computer 60 that is connected to a fluid flow valve of each servocontrol via usual links. In addition, the collective pitch control channel 58 may also include usual links that are connected mechanically to the collective pitch control 45. The collective pitch control channel 58 may also include at least one collective pitch sensor 450 that is in communication with the control computer 60, the collective pitch sensor 450 emitting a signal that varies with the value of the collective pitch component. For example, such a collective pitch sensor 450 is arranged on a mixing unit (not shown).

In this control system 40, the yaw control 55 is connected via a mechanical first main channel 61 to a mechanical mixing unit 80 of a downstream mechanical channel 70. This mechanical first main channel 61 may include at least one rigid link 66, at least one yaw series actuator 62, and members 63 generating friction forces. For example, a rigid link may take the form of a connecting rod or of some equivalent means. A usual device 64 may also damp the movements of the yaw control 55. At least one yaw trim actuator 65 may be arranged in parallel with the mechanical first main channel 61. The yaw trim actuator 65 and the yaw series actuator 62 are controlled by the control computer 60.

In addition, the mechanical first main channel 61 may include a variable-geometry mechanical device 67 that, for example, serves to modify an order given by the yaw control 55 as a function of an action to move the collective pitch control 45 via movement of the collective pitch control channel 58 or of a dedicated mechanical channel and/or of an action to move the thrust control 50 directly or via the control computer 60. The control computer 60 may also act on an order given by the yaw control 55, e.g. by controlling the yaw series actuators 62.

In addition, for each propeller, 10, 15, the mixing unit 80 is coupled to a control rod for controlling a hydraulic valve 85 via a linkage secondary channel 86 of the downstream linkage channel 70, and, for example, via a ball control. As a function of the orders given by the pilot, the control rods are moved so that the hydraulic valves 85 connect servo-controls 880 to the hydraulic circuit of the hybrid helicopter 1 so as to modify the first pitch of the first blades 11 and the second pitch of the second blades 16. A modulation system 87 may modulate the orders transmitted by the mixing unit 80. For example such a modulation system 87 includes a repeater rod for the hydraulic valve 85, which rod can be moved by an actuator under order of the control computer 60.

Furthermore, the thrust control 50 is coupled to the mixing unit 80, e.g. via a linkage second main channel 53, the linkage second main channel 53 including at least one thrust series actuator 54 connected mechanically to the mixing unit 80. Each thrust series actuator 54 may receive an analog, digital, electrical, or optical signal issued by the control computer 60 under order from the thrust control 50. As a result, the thrust control 50 continuously issues a control signal that is transmitted to the control computer 60, which control computer 60 controls one or more thrust series actuators 54 accordingly.

Optionally, a backup control 201 may also be put in place, and, for example, a backup control connected mechanically to the linkage second main channel 53. In one example, a lever may move the linkage second main channel 53.

Optionally, a movement prevention control 202 may also be considered for preventing the backup control 51 from moving.

Under such conditions, the mixing unit 80 sums the order for modifying the mean pitch component that is given by the thrust control 50 via the thrust series actuators 54, and the order for changing the differential pitch component that is given by the yaw control 55. Orders for modifying the mean pitch component and for changing the differential pitch component may also be issued by the control computer and transmitted to the various series and trim actuators 62, 54, 65, or indeed to the device 87. More precisely, when the thrust control 50 is moved, a control signal is transmitted to the control computer 60. The control computer 60 then optionally controls one or more thrust series actuators 54 for setting in motion the mixing unit 80 in order to modify the mean pitch components of the first blades 11 and of the second blades 16.

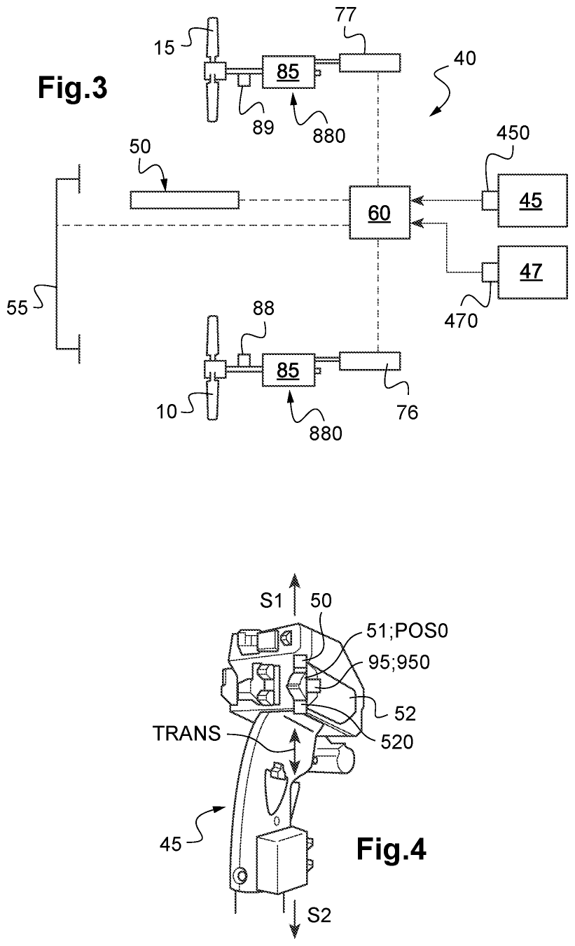

FIG. 3 shows another example of a control system for controlling the propellers 10, 15.

In this example, the yaw control 55, the thrust control 50, the collective pitch control 45 and the cyclic pitch control 47 communicate with the control computer 60. The control computer 60 is in communication with actuators 76, 77 that are connected to respective ones of the hydraulic valves 85.

The control computer 60 then applies one or more laws or relationships stored in a memory for controlling the actuators 76, 77 as a function of the signals issued by the yaw control 55, by the thrust control 50, and by the collective pitch control 45, or indeed by the cyclic pitch control 47.

Other architectures may be considered without going beyond the ambit of the invention.

In another aspect, the hybrid helicopter may include a human-machine interface 99 for choosing a physical parameter for a control setpoint. This physical parameter may, as chosen by a pilot, be a longitudinal acceleration setpoint or a setpoint for a rate and a direction of pivoting of the blades of the propeller(s), and thus of the first blades 11 or indeed, where applicable, of the second blades 16, or a power setpoint.

This human-machine interface 99 transmits a control signal, e.g. an analog or digital control signal, carrying the chosen parameter to the control system 40 and optionally to the control computer 60.

For example, the human-machine interface 99 may be a usual touch, voice, or visual interface. The human-machine interface 99 shown includes a button but any type of interface is possible, such as a touch screen, a rotary selector, etc.

Alternatively, or additionally, a human-machine control 990 may enable an automatic piloting mode to be selected, said human-machine interface 990 transmitting a control signal carrying the chosen automatic piloting mode to the control system. This human-machine control 990 transmits a control signal, e.g. an analog or digital control signal, carrying the chosen mode to the control system 40 and optionally to the control computer 60.

For example, the human-machine control 990 may be a usual touch, voice, or visual interface. The human-machine control 990 shown includes a rotary selector but any type of interface is possible, such as a touch screen, a button, etc.

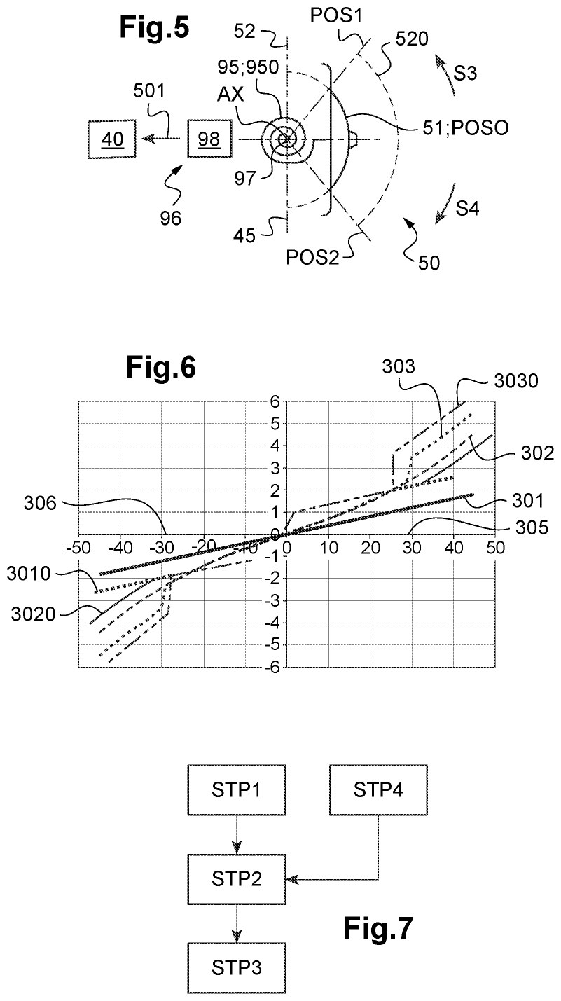

Furthermore, and with reference to FIGS. 4 and 5, the thrust control 50 may include a control member 51 that is movable relative to a carrier member 52. These figure show a carrier member 52 that includes the thrust control 50 by way of example. The term “carrier member” is used to mean a member that carries the control member and relative to which the control member can move. The term “carrier member” may also, for example, mean a printed circuit or the like carrying the control member 51.

The control member 51 is movable by a pilot relative to a carrier member 52 along a movement path 520, and can reach any position along said movement path 520 in the range from a first end position POS1 to a second end position POS2, as shown in FIG. 5.

In the first variant shown in FIG. 4, the control member is in the form of a button that is movable in translation TRANS only, in two opposite directions S1, S2, like a slide. In the second variant of FIG. 5, the control member 51 is movable in rotation ROT only, about an axis of rotation AX in two opposite directions S3, S4.

Regardless of the variant, the thrust control 50 may include a return system 95 that exerts a return force on the control member 51 so as to place it in a reference position POS0. For example, such a return system comprises at least one spring and/or an electric actuator 950 generating a force relationship that is stored in a memory. For example, the electric actuator 950 includes a motor that generates a force on the control member 51 that varies as a function of the position of the control member 51, it being possible for this position to be measured by means of a usual sensor.

Such a return force may vary in compliance with a force relationship.

FIG. 6 shows a graph having a position plotted along the abscissa axis and a force plotted up the ordinates. This graph shows six different relationships that can be obtained in usual manner.

In a first force relationship 301, the return force varies linearly as a function of the position of the control member 51 relative to the carrier member 52.

In a second force relationship 302, the return force does not vary linearly as a function of the position of the control member 51 relative to the carrier member 52.

In a third force relationship 303, not only does the return force not vary linearly as a function of the position of the control member 51 relative to the carrier member 52 but, in addition, the force relationship includes thresholds 305, 306 from which the return force varies significantly.

The fourth force relationship 3010, the fifth force relationship 3020, and the sixth force relationship 3030 are respectively types of the first force relationship 301, of the second force relationship 302, and of the third force relationship 303, each with a force threshold to overcome to leave the reference position POS0 situated at the origin of the graph that is shown.

Furthermore, and with reference to FIG. 5, for example, the thrust control 50 includes a signal generator 96 that continuously, and at least outside failure situations, issues to the control system 40 at least one control signal that varies at each instant as a function of the current position of the control member relative to the carrier member 52. The signal generator 96 may be offset in part or in full relative to the control member.

For example, the signal generator 96 includes an electric circuit 98 that co-operates with a potentiometer 97, said potentiometer 97 having an electric resistance that varies as a function of the current position of the control member 51.

FIGS. 4 and 5 show examples. The thrust control 50 may include any device provided with a movable control member and continuously generating a control signal.

FIG. 7 shows the method of the invention.

At each instant, the method includes a transmission step STP1 during which the thrust control 50 transmits a control signal to the control system 40. The thrust control 50 thus continuously issues a control signal that is transmitted to the control system 50, and, for example, to the control computer 60. Said control signal carries a control setpoint.

Then, during a processing step STP2, the control system 40 processes the control signal so as to control the propeller(s). For example, the control computer 60 receives the control signal, analyzes it and processes it so as to generate a pitch setpoint or indeed a mean pitch setpoint when the pitch of the blades of the propeller(s) comprises a mean pitch component and a differential pitch component.

Depending on the implementation, the control signal carries a value of a control setpoint for controlling a physical parameter that may be a longitudinal acceleration setpoint or carries a setpoint for a rate and a direction of pivoting of the blades of the propeller(s), and thus of the first blades 11 and, where applicable, of the second blades 16, or carries a power setpoint.

In one possibility, the method may include a selection step STP4 with a human-machine interface 99 shown in FIG. 1 in order to choose the physical parameter carried by the control signal. This step may optionally be undertaken in flight.

In other variants, the physical parameter carried by the control signal is fixed or else varies as a function of the piloting mode engaged in an automatic piloting system.

For example, during the selection step STP4, a human-machine control 990 enables a pilot to choose a selected automatic piloting mode to be applied by the control computer 60 and/or by another computer. The physical parameter associated with the control setpoint can then vary as a function at least of the selected automatic piloting mode. For example, the control computer includes a memory associating each piloting mode with a physical parameter.

Independently of this aspect, the control system 40 and, for example, the control computer 60 thus receives the control signal carrying the control setpoint and deduces therefrom, by usual means, the value of the control setpoint of the physical parameter to be reached. For example, the control computer 60 includes an analog-to-digital converter that converts the control signal so as to act, depending on the variant, to deduce therefrom a longitudinal acceleration setpoint or a setpoint for a rate and a direction of pivoting of the first blades 11 or indeed of the second blades 16, or a power setpoint. In another example, the control signal is subtracted from a signal carrying a current value of the physical parameter that is the subject of the control setpoint so as to generate an error signal, said error signal being converted into a digital value representing the value of the control setpoint.

Independently of the manner in which it is obtained, said control setpoint is then transformed into a pitch setpoint, e.g. by means of one or more laws or relationships. Each law or relationship may take the form of a table of values, of a mathematical relationship, etc.

The control system 40 then processes the pitch setpoint during a control step STP3 for controlling the pitch of the blades of the propeller(s), namely the first pitch and, where applicable, the second pitch, in order to comply with the control setpoint given by the pilot by moving the control member. For example, the control computer or some other computer injects the pitch setpoint into at least one open or closed regulation loop so as to issue a signal to at least one thrust actuator 54.

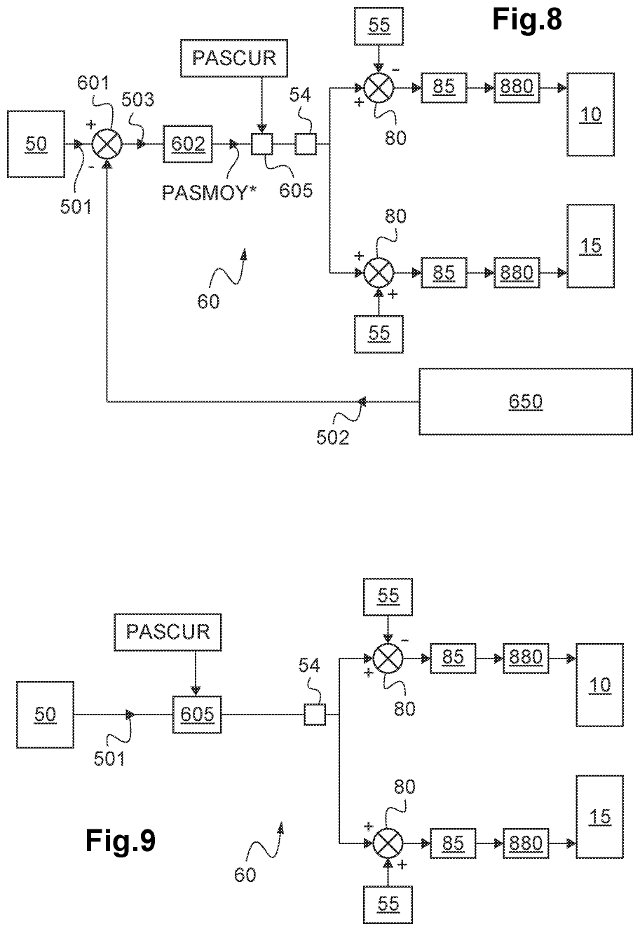

FIG. 8 is a view showing a direct regulation mode implemented by a control signal carrying a longitudinal acceleration setpoint.

The thrust control 50 continuously generates the control signal 501. The control computer 60 includes a subtraction module 601 that subtracts from the control signal 501 a longitudinal acceleration measurement signal 502 so as to obtain an error signal 503. Alternatively, digital processing may be considered.

This longitudinal acceleration measurement signal 502 is issued by a usual acceleration sensor 650. For example, a pitch setpoint of the mean pitch setpoint type PASMOY* then comes from a proportional-integral-derivative correction module 602 that receives the error signal 503 as input. A control module 605 of the control computer 60 receives the pitch setpoint and information relating to a current pitch PASCUR for then controlling at least one thrust actuator 54.

To this end, the control computer may be in communication with at least one sensor that measures the current pitch PASCUR or the mean pitch component, as applicable. As shown in FIG. 1, a first measurement sensor 88 and a second measurement sensor 89 transmit signals to the control computer, the mean pitch component being equal to the half-sum of the measured first pitch and of the measured second pitch and forming the information relating to a current pitch.

Such a method may also be applied to a thrust setpoint.

FIG. 9 shows a direct regulation mode implemented by a control signal that carries a setpoint for a rate and a direction of pivoting of the first blades 11 and, where applicable, of the second blades 16.

The thrust control 50 continuously generates the control signal 501. A control module 605 of the control computer determines the value of the rate of pivoting setpoint by processing the control signal and then transforms it into a pitch setpoint, e.g. by applying one or more laws or relationships stored in a memory. The control computer then processes the pitch setpoint for generating a signal transmitted to at least one thrust actuator 54 so as to pivot the blades of the propeller(s) about their respective pitch axes at the specified rate of pivoting. To this end, the control computer may be in communication with at least one sensor that measures the current pitch PASCUR or the mean pitch component, as applicable, of the propeller(s).

By way of illustration, the pilot moves the control member into a particular position. This control member transmits a control signal that carries a rate of pivoting setpoint indicating that the pitch of the propeller(s) should be increased at a rate of 0.1 degrees per second. In this illustration, the control computer may have a processing time of one second. In other words, the control computer applies the method every second. The current pitch is 2 degrees. At the current iteration, the control computer computes the pitch to be reached for the blades of the propeller(s) to move at the specified rate. The control computer thus indicates to at least one actuator to reach a pitch of 2.1 degrees. At the next iteration, the control computer indicates that a pitch of 2.2 degrees should be reached, and so on so long as the control member remains in the particular position.

Other modes of operation may be considered by using a control signal issued continuously and carrying a control setpoint, and in particular modes that are protected. For example, the power, torque, or speed of rotation protected modes of FR 2 946 316 may be considered.

Naturally, the present invention may be subjected to numerous variations as to its implementation. Although several implementations are described above, it should readily be understood that it is not conceivable to identify exhaustively all possible implementations. It is naturally possible to replace any of the means described with equivalent means without going beyond the ambit of the present invention.

For example, the hybrid helicopter may include a single propeller and/or a plurality of lift rotors.

What is claimed is:

1. A method of controlling at least one first propeller of a hybrid helicopter, the hybrid helicopter including a lift rotor, the hybrid helicopter including a control system connected to first blades of the first propeller, the hybrid helicopter having a thrust control for controlling a first pitch of the first blades, the thrust control being in communication with the control system, the thrust control including a control member that is movable with at least one degree of freedom relative to a carrier member;
wherein the method includes the following steps:
continuously transmitting with the thrust control a control signal carrying a control setpoint to the control system, the control signal being an analog electrical signal and at each instant being a function of a current position of the control member relative to the carrier member, at least outside failure situations;
transforming with the control system the control setpoint into a pitch setpoint; and
controlling with the control system the first pitch by applying the pitch setpoint.

2. The method according to claim 1,
wherein the method includes a step of using a return system to apply a return force to the control member so as to place the control member in a reference position relative to the carrier member in the absence of any force being exerted by a human pilot on the control member.

3. The method according to claim 2,
wherein the return force varies in compliance with a force relationship, the force relationship providing the return force exerted on the control member by the return system as a function of the position of the control member relative to the carrier member.

4. The method according to claim 3,
wherein the force relationship is non-linear.

5. The method according to claim 1,
wherein the at least one degree of freedom comprises a degree of freedom to move in rotation.

6. The method according to claim 1,
wherein the at least one degree of freedom comprises a degree of freedom to move in translation.

7. The method according to claim 1,
wherein the control setpoint is a longitudinal acceleration setpoint.

8. The method according to claim 1,
wherein the control setpoint is a setpoint for a rate and a direction of pivoting of the first propeller blades about their pitch axes.

9. The method according to claim 1,
wherein the control setpoint is a power setpoint.

10. The method according to claim 1,
wherein the method includes a selection step using a human-machine interface to select a physical parameter for the control setpoint, the physical parameter being chosen by a pilot and being a longitudinal acceleration setpoint or a setpoint for a rate and a direction of pivoting of the first blades, or a power setpoint, the human-machine interface transmitting a control signal carrying the chosen parameter to the control system.

11. The method according to claim 1,
wherein the method includes a selection step using a human-machine control to select a selected automatic piloting mode, a physical parameter of the control setpoint varying as a function of the selected piloting mode, the human-machine control transmitting a control signal carrying the selected automatic piloting mode to the control system.

12. A hybrid helicopter provided with at least one first propeller, the hybrid helicopter Including a lift rotor, the hybrid helicopter including a control system connected to first blades of the first propeller, the hybrid helicopter having a thrust control in communication with the control system, the thrust control including a control member that is movable with at least one degree of freedom relative to a carrier member;
wherein the control system is configured to apply the method according to claim 1.

13. The hybrid helicopter according to claim 12,
wherein the thrust control includes a return system that exerts a return force on the control member so as to place the control member in a reference position in the absence of any force being exerted by a human pilot on the control member.

14. The hybrid helicopter according to claim 12,
wherein the return system includes an electric actuator.

15. The hybrid helicopter according to claim 12,
wherein the hybrid helicopter includes a human-machine interface for choosing a physical parameter for the control setpoint, the physical parameter being chosen by a pilot and being a longitudinal acceleration setpoint or a setpoint for a rate and a direction of pivoting of the first blades, or a power setpoint, the human-machine interface transmitting a control signal carrying the chosen parameter to the control system.

16. The hybrid helicopter according to claim 12,
wherein the hybrid helicopter includes a human-machine control for choosing a selected automatic piloting mode from among a plurality of automatic piloting modes, the human-machine control transmitting a control signal carrying the selected automatic piloting mode to the control system.

17. The hybrid helicopter according to claim 12,
wherein the control member is movable in rotation.

18. The hybrid helicopter according to claim 12,
wherein the control member is movable in translation.
